(19) United States
(12) Patent Application Publication
(10) Pub. No.: US 2015/0259760 A1
(43) Pub. Date: Sep. 17, 2015

(54) METHOD FOR PRODUCING STEEL

(71) Applicant: VOESTALPINE STAHL GMBH, Linz (AT)

(72) Inventors: Wolfgang Eder, Linz (AT); Thomas Bürgler, Steyregg (AT); Peter Schwab, Linz (AT)

(21) Appl. No.: 14/428,206

(22) PCT Filed: Sep. 10, 2013
(86) PCT No.: PCT/EP2013/068726

§ 371 Date: Mar. 13, 2015

(30) Foreign Application Priority Data
Sep. 14, 2012 (DE) 10 2012108 631.1
Sep. 28, 2012 (DE) 10 2012 109 284.2
Apr. 19, 2013 (DE) 10 2013 104 002.0

(51) Int. Cl. C21B 13/00; C01B 3/02; C22C 37/00; C25B 1/04; C22C 38/00

(52) U.S. Cl. CPC C21B 13/0073; C25B 1/04; C22C 38/00; C22C 37/00; C01B 3/02

(57) ABSTRACT

A method for producing steel in which iron ore is reduced with hydrogen and the resulting intermediate product of reduced iron ore and possibly accompanying substances is subjected to further metallurgical processing; the hydrogen is produced through electrolysis of water; the electrical energy required for the electrolysis is regenerative energy from hydroelectric and/or wind and/or photovoltaic sources or other regenerative forms of energy and the hydrogen and/or the intermediate product is produced regardless of the current demand, whenever enough regeneratively produced electrical energy is available; and unneeded intermediate product is stored until there is demand or it is used so that the regenerative energy that is stored therein is also stored and a method for storing discontinuously produced energy in which the discontinuously produced energy, when it is present or after its production, is conveyed into a process in which a storable intermediate product is produced from a source material and the storable intermediate product is stored until it is required and retrieved for the production of an end product.

### FIELD OF THE INVENTION

The invention relates to a method for producing steel in which iron ore is reduced with hydrogen and the resulting intermediate product of reduced iron ore and possibly accompanying substances is subjected to further metallurgical processing, and a method for storing discontinuously produced energy.

### BACKGROUND OF THE INVENTION

Steel production is currently carried out in a variety of ways. Classic steel production is carried out by producing pig iron in the hot furnace process, primarily out of iron oxide carriers. In this method, approx. 450 to 600 kg of reducing agent, usually coke, is consumed per metric ton of pig iron; this method, both in the production of coke from coal and in the production of the pig iron, releases very significant quantities of CO₂. In addition, so-called “direct reduction methods” are known (methods according to the brands MIDREX, FINMET, ENERGIRON/HYL, etc.), in which the sponge iron is produced primarily from iron oxide carriers in the form of HDRI (hot direct reduced iron), CDRI (cold direct reduced iron), or so-called HBI (hot briquetted iron).

There are also so-called smelting reduction methods in which the melting process, the production of reduction gas, and the direct reduction are combined with one another, for example the methods of the brands COREX, FINEX, HiSmelt, or HiSarna.

Sponge irons in the form of HDRI, CDRI, and HBI usually undergo further processing in electric furnaces, which is extraordinarily energy-intensive. The direct reduction is carried out using hydrogen and carbon monoxide from methane and synthesis gas if necessary. For example, in the so-called MIDREX method, first methane is transformed according to the following reaction:

CH₄+CO₂=2CO+2H₂

and the iron oxide reacts with the reduction gas, for example according to the following formula:

Fe₂O₃+6CO(H₂)=2Fe+3CO₂(H₂O)+3 CO(H₂).

This method also emits CO₂.

DE 198 53 747 C1 has disclosed a combined process for the direct reduction of fine ores in which the reduction is to be carried out with hydrogen or another reduction gas in a horizontal turbulence layer.

DE 197 14 512 A1 has disclosed a power station with solar power generation, an electrolysis unit, and an industrial metallurgical process; this industrial process relates either to the power-intensive metal production of aluminum from bauxite or is intended to be a metallurgical process with hydrogen as a reducing agent in the production of nonferrous metals such as tungsten, molybdenum, nickel, or the like or is intended to be a metallurgical process with hydrogen as a reducing agent using the direct reduction method in the production of ferrous metals. The cited document, however, does not explain this in detail.

WO 2011/018124 has disclosed methods and systems for producing storable and transportable carbon-based energy sources using carbon dioxide and using regenerative electrical energy and fossil fuels. In this case, a percentage of regeneratively produced methanol is prepared together with a percentage of methanol that is produced by means of non-regenerative electrical energy and/or by means of direct reduction and/or by means of partial oxidation and/or reforming

In all of the steel production methods known up to this point, it is disadvantageous that there is a lack of a sustainable, comprehensive production concept based on regenerative resources for steel production on an industrial scale.

The object of the invention is to create a method with which pig iron and in particular steel can be produced on an industrial scale in a CO2-neutral fashion.

### SUMMARY OF THE INVENTION

According to the invention, the steel production is carried out at least partially, preferably completely, with regenerative energy; in this case, on the one hand, a direct reduction method is used and on the other hand, the intermediate product obtained in the direct reduction method is correspondingly processed further, for example in an electric arc furnace. However, a use in the LD process and/or in a blast furnace would also be possible. A particular advantage is that the intermediate product produced by means of regenerative energy can be stored until it is processed further, which means that the method according to the invention permits a storage of regenerative energy. Up to now, this very storage of regenerative energy has presented a very large problem since in particular, electrical energy that is generated from wind or sun depends on climatic conditions that are not always the same. Even hydroelectrically generated electrical energy is not always available. Often, the consumers are not in the same locations as the production of regenerative energy. This problem of storage and of transporting stored energy is solved by means of the invention since the intermediate product produced according to the invention can be efficiently transported in small units and in any quantity to any location, for example by marine transport.

In the method according to the invention, this electrical energy generated from wind, hydro, or solar energy is used to produce hydrogen from water by electrolysis. Preferably at the site of the production of the hydrogen, a direct reduction system is operated, which is used for reducing iron ores—which are likewise preferably prepared with electrical energy produced in this way. The intermediate product obtained in this way is an ideal way to store this regenerative energy, can be stored until it is used, and is accessible via any form of transportation to a system for processing it further, particularly when it is needed there. In particular, this intermediate product can be produced at its production site—in large quantities that exceed the present requirement—when the corresponding electrical energy is available in sufficient quantity. If this energy is not available, then there are sufficient quantities of the intermediate product and thus also of the energy in order to be able to meet the need.

Operating a corresponding electrical arc, likewise particularly preferably using only energy produced from wind-, hydroelectric-, or solar energy, succeeds in achieving a CO₂-free steel production and also in storing regenerative energy. Alternatively, the intermediate product can also be used with a blast furnace or the LD process.

According to the invention, the hydrogen from the regenerative processes can be used with carbon-containing or hydrogen-containing gas flows such as CH4, COG, synthesis gas etc., in a direct reduction system. The ratio of hydrogen from the regenerative processes to carbon-containing or hydrogen-containing gas flows can be continuously varied as a function of availability. For example, if a very large amount of hydrogen is available, this can be used up to almost 100% for the direct reduction. The rest is made up of the minimally required carbon-containing or hydrogen-containing gas flow for adjusting the percentage of carbon. If necessary, however, it is also possible to switch to purely carbon-containing or hydrogen-containing gas flows (for example natural gas, biogas, gas from pyrolysis, renewable resources).

Preferably, however, the method is carried out so that regenerative energy, when present, is used to produce as much hydrogen as the existing energy permits and this hydrogen is used for the direct reduction. It goes without saying that carbon-containing or hydrogen-containing gas flows also include gas flows from biogas production and pyrolysis of renewable resources.

Excess hydrogen that cannot be used immediately can be temporarily stored.

This temporary storage of hydrogen can, for example, be provided by a gas holder and the adjustment of the contents of carbon-containing or hydrogen-containing gas flows can be carried out by means of a predictive control. This predictive control can measure the predicted yield/production quantity of hydrogen or regenerative energy, but can also be used, for example, to estimate the production quantity of regenerative energy based on weather forecasts. Demand forecasts of other external consumers can also flow into this predictive control so that the electrical energy produced from regenerative sources is optimally used in the most economical fashion.

The temperatures of the gas flow that prevail in this case are adjusted by heating—for example with reformers, heaters, or partial oxidation—to 450° C. to 1200° C., preferably 600° C. to 1200° C., in particular 700° C. to 900° C. and then introduced into the direct reduction method in order to perform a chemical reaction there. In addition, the gas flow that exits the direct reduction method can be fed back into the process as a carbon-containing or hydrogen-containing gas flow.

The resulting possible intermediate products according to the invention are HBI, HDRI, or CDRI.

In this case, excess pressures of 0 bar to 15 bar are adjusted. For example, excess pressures of approx. 1.5 bar are preferred in the MIDREX process and excess pressures of approximately 9 bar are preferred in the Energiron process.

When regeneratively produced hydrogen is mixed with carbon-containing or hydrogen-containing gas flows, the carbon content can be adjusted in an ideal fashion and in fact can be adjusted to 0.0005% to 6.3%, preferably 1% to 3%, and directly incorporated into the intermediate product as C or Fe₃C. An intermediate product of this kind is ideally adjusted in terms of the carbon content and is particularly well suited to further processing since it contributes the carbon content that is required for the metallurgical process.

### BRIEF DESCRIPTION OF THE DRAWINGS

The invention will be explained by way of example in conjunction with the drawings. In the drawings:

FIG. 1 shows an overview of the method according to the invention in an exemplary embodiment (electric arc furnace);

FIG. 2 shows an overview of the method according to the invention in a second exemplary embodiment (LD process);

FIG. 3 schematically depicts the flows of materials and energy.

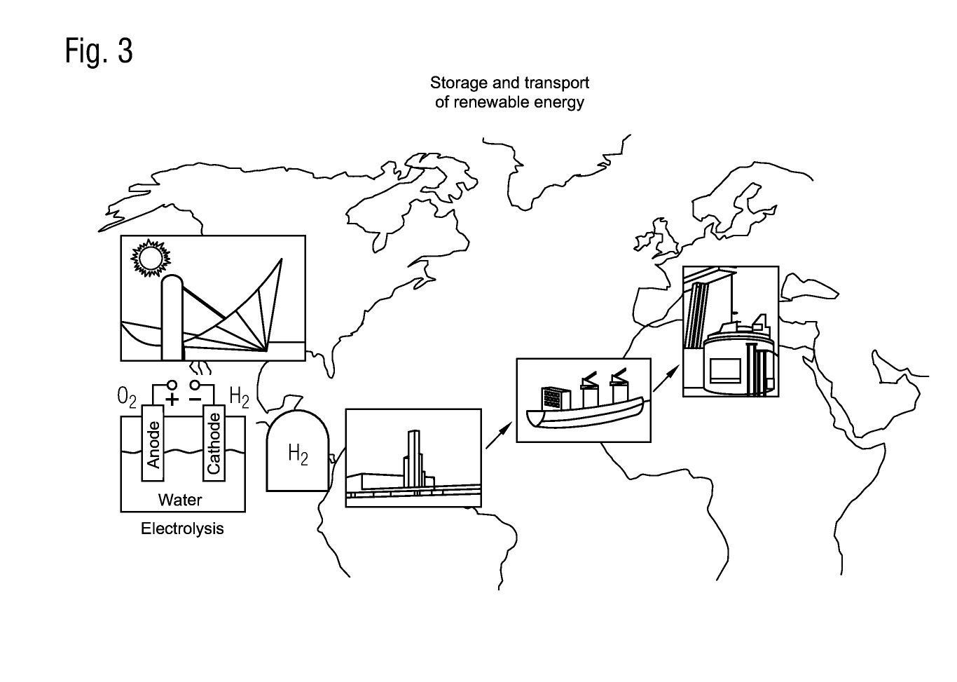

### DETAILED DESCRIPTION OF THE PREFERRED EMBODIMENTS

According to the invention, the reduction of the primarily iron oxide carriers is carried out by means of hydrogen and if necessary carbon carriers, either CO₂ from industrial processes with inevitable CO₂ emissions or methane particularly from regenerative processes such as biogas production.

As is known, the iron reduction can occur in three possible ways:
“classic” blast furnace process—production of pig iron from iron carriers and reducing agents, primarily coke
direct reduction—for example MIDREX—sponge iron (HDRI, CDRI, and HBI),
smelting reduction—combination of the smelting process, reduction gas production, and direct reduction, for example COREX OR FINEX.

Iron reduction (hematite, iron(III)) oxide is carried out by means of:

carbon monoxide: Fe₂O₃+6CO→2Fe+3CO+3CO₂

hydrogen: Fe₂O₃+6H2→2Fe+3H₂+3H₂O

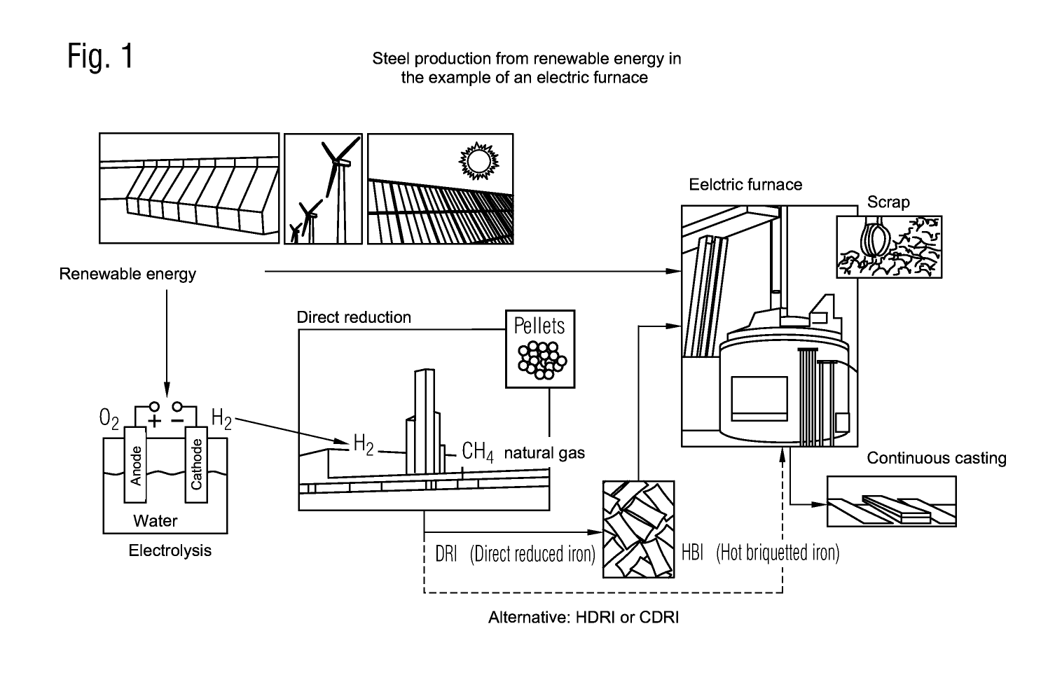

In this case, the intermediate product obtained in the direct reduction method can be so-called DRI (direct reduced iron) or HBI (hot briquetted iron), which can be smelted into steel in accordance with FIG. 1 in an electric arc furnace, possibly with the addition of scrap.

FIG. 1 also shows that HDRI or CDRI can also be conveyed, without the “detour” of HBI production, directly into the electric furnace.

According to the invention, HBI can also be used in other metallurgical processes in addition to the electric arc furnace process, e.g. in the blast furnace process or as a scrap replacement in the LD process.

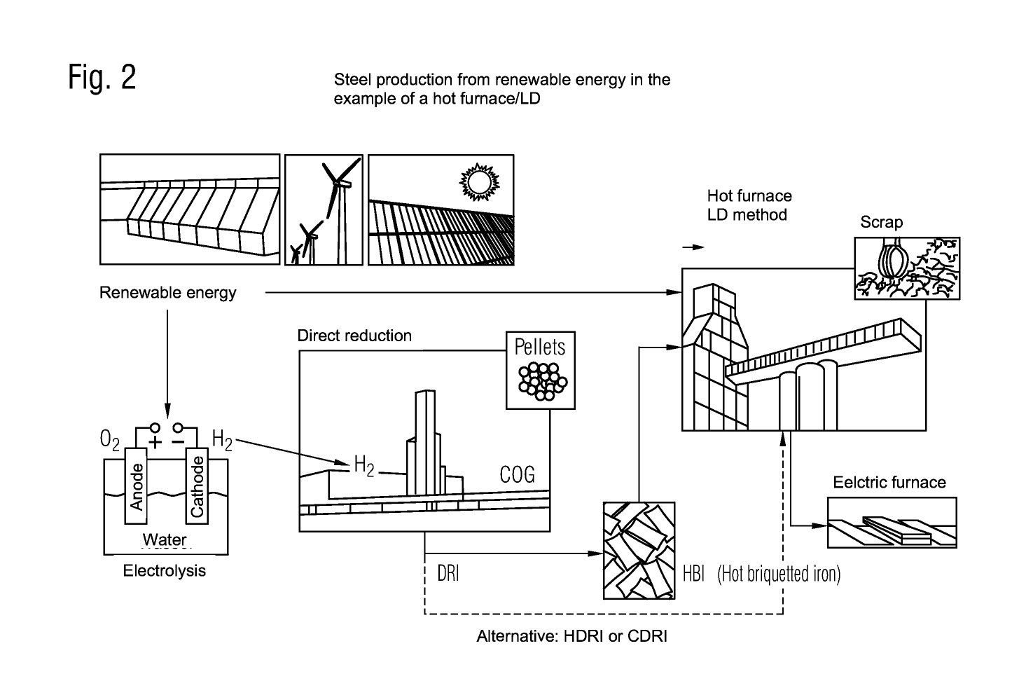

Such an embodiment is shown in FIG. 2. In this case, it should also be noted that CDRI and HDRI can also be conveyed directly into the blast furnace process or LD process.

In a preferred embodiment, in order to compensate for temporary fluctuations in the production of renewable energy, this energy can be stored in the form of hydrogen if a surplus of it is available. This storage can occur, for example, in a gas holder. Such a store can then be used in the event of fluctuations. Temporary fluctuations can be predictable, e.g. at night in solar installations, or unpredictable, e.g. fluctuations in wind intensity in wind energy plants.

Longer-term fluctuations that can occur among other things due to the different seasons can preferably be factored into the energy storage in the form of HBI.

If necessary, it is also possible to draw on the use of carbon-containing or hydrogen-containing gases such as natural gas and a use of hydrogen can be optimally carried out only with sufficiently renewable electrical power.

This advantageously yields the optimal potential uses of regenerative energy since this energy can be used continuously as a function of the availability of the corresponding form of energy and the remaining energy that is lacking can be supplemented as needed by means of other energy carriers. It is thus possible at any time to reduce the emission of CO2 to the minimum possible at this moment through the use of regenerative energy sources.

Another advantage of the invention lies in the spatial decoupling of the locations of the production of regenerative energy and the use of this energy. For example, solar power stations can be constructed in warmer regions with favorable amounts of solar radiation in which space is plentiful, whereas steel mills are often found in the vicinity of rivers or seas.

Since the energy produced is stored in HBI, for example, it can be transported easily and efficiently.

1. A method for producing steel, comprising:
reducing iron ore with hydrogen and subjecting a resulting intermediate product of reduced iron ore and possibly accompanying substances to further metallurgical processing, wherein the hydrogen is produced through electrolysis of water and electrical energy required for the electrolysis is regenerative energy from hydroelectric and/or wind and/or photovoltaic sources or other regenerative forms of energy and
the hydrogen and/or the intermediate product is produced regardless of the current demand, whenever enough regeneratively produced electrical energy is available, where
unneeded intermediate product is stored until there is demand or it is used so that the regenerative energy that is stored therein is also stored, and in reducing the iron ore to produce the intermediate product, a carbon-containing or hydrogen-containing gas is added to the hydrogen in order to incorporate carbon into the intermediate product; and the hydrogen for the reduction has at least enough carbon-containing or hydrogen-containing gas added to it to make the carbon content in the intermediate product 0.0005 mass % to 6.3 mass %.

2. (canceled)

3. The method according to claim 1, wherein the carbon-containing or hydrogen-containing gas, methane, or other carbon-containing gases are from industrial processes or from biogas production or pyrolysis, or are synthesis gas from biomass.

4. The method according to claim 1, wherein the hydrogen for the reduction has at least enough carbon-containing or hydrogen-containing gas added to it to make the carbon content in the intermediate product 1 mass % to 3 mass %.

5. The method according to claim 1, wherein the reduction gas composed of hydrogen and possibly a carbon-containing gas is introduced into the reduction process at a temperature of 450° C. to 1200° C.

6. The method according to claim 1, wherein excess pressure in the reduction is between 0 bar and 15 bar.

7. The method according to claim 1, wherein a ratio between hydrogen from regenerative production and carbon-containing or hydrogen-containing gas flows is varied continuously as a function of availability; when there is sufficient regenerative energy, hydrogen from the production with regenerative energy is used and in the absence of regenerative energy, then the system switches to purely carbon-containing or hydrogen-containing gas flows.

8. The method according to claim 1, wherein an adjustment of the content of hydrogen and/or carbon-containing or hydrogen-containing gas flows in the overall gas flow is carried out using a predictive control; the predictive control is used to measure a predicted yield/production quantity of hydrogen and/or regenerative energy and/or carbon-containing or hydrogen-containing gas flows from biogas production or from pyrolysis of renewable resources and/or forecasts flow into an estimation of regenerative energy; and demand predictions of other external consumers also flow into the process, thus permitting the electrical energy from regenerative sources to be distributed optimally and in a most economical fashion.

9. The method according to claim 1, wherein gas flow that is emitted as exhaust by the direct reduction system is conveyed into the process as a carbon-containing or hydrogen-containing gas flow.
